(19) United States
(12) Patent Application Publication
(10) Pub. No.: US 2004/0000768 A1
(43) Pub. Date: Jan. 1, 2004

(54) Sparking skateboard

(76) Inventor: Dan Allen Miller, Santa Ana, CA (US)

Correspondence Address: LAW OFFICES OF CLEMENT CHENG, 17220 NEWHOPE STREET #127, FOUNTAIN VALLEY, CA, 92708, US

(21) Appl. No.: 10/180,767

(22) Filed: Jun. 26, 2002

(51) Int. Cl. B62M 1/00

(52) U.S. Cl. 280/87.042

(57) ABSTRACT

This invention comprises four different embodiments. In the first embodiment, sparking inserts are located on the lower portion of the skate truck. In the second embodiment, the sparking inserts are located on the skateboard board between the skate trucks. In the third embodiment, the sparking inserts are located on the nose or tail of the skateboard board. In the fourth embodiment, the sparking inserts are located on the wheels.

### BACKGROUND

Skateboarding has become a popular sport and has progressed to become an athletic activity. The skateboarding sport has certain unique terminology.

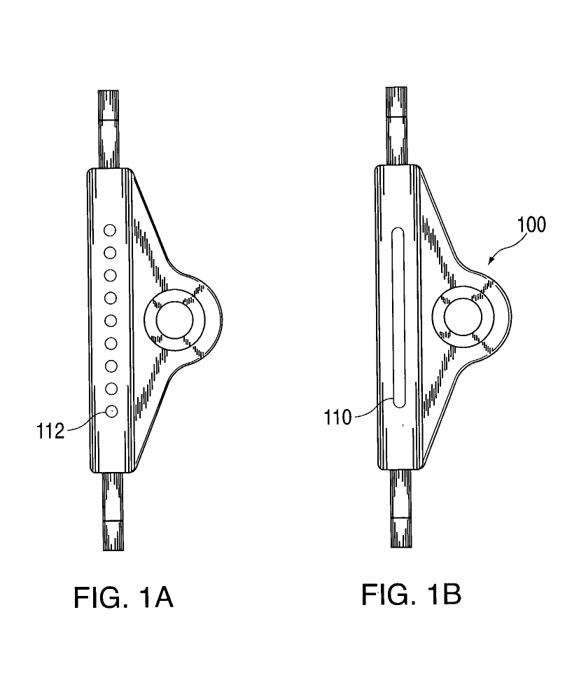

A skateboard truck (FIG. 1B, 100) is a support structure commonly made of metal that holds a pair of wheels. Skateboards commonly use a pair of trucks to hold two pairs of wheels. The truck has a flat surface supporting the board. The board or deck is usually made of wood. The flat surface is mounted to the board by screws. Optionally, an intermediate riser can be added between the flat surface of the truck and the board.

The skateboard rider balances on the board and adjusts the direction of travel by adjusting the pressure of his weight at various locations on the board. The typical truck assembly, which has been used for roller skates and skateboards, has an axle that is supported at two places. One of these places is a pivot fixture and the other is a kingpin fixture where the support ring is held between two cushions on an angled kingpin. Conventional skateboard trucks may include a rubber cushion intended to provide a restoring force to the truck when a user of the skateboard effects a turn by shifting his weight. Kimmell U.S. Pat. No. 4,071,256, the disclosure of which is incorporated in its entirety herein by reference, discloses a skateboard truck, which includes such a cushion. A nose is the front part of the skateboard and a tail is the back part of the skateboard.

Skaters perform tricks of varying difficulty that wear certain portions of a skateboard. Sliding a skateboard on its trucks performs a Grind. A skater usually slides the lower portion of a truck along a rail. The friction between a rail and a truck can be high, hence the name ‘grind’. Skaters may wax up a ledge or a rail to make it easier to grind. A slide is similar to a grind, but the railing contacts the board instead of the trucks.

Rails may be elevated from the ground. In this case, skateboarders can Ollie by jumping and grabbing the board so that the trucks are aligned with the rail. The skateboarder can then slide along the rail upon the trucks where the rail runs between the wheels in the truck. This can create a grinding noise. Sometimes skaters bail from a grind by jumping away from the skateboard, so as to avoid injury.

Skaters will Ollie by jumping and grabbing the board to lift it under them. A skater may grab a board during an Ollie, or after coming off a ramp. A skater performs a kick flip by rolling the board 360 degrees beneath him while airborne. Experienced skaters can perform ambidextrous tricks called Fakies where the skater's weaker foot is usually on the board's tail. Some skaters can ‘manual’ and roll on only two wheels. Certain skaters prefer to mongo, and propel themselves with their front foot instead of their back foot. Mongo can sometimes appear to be awkward ‘flow’, which is a general term for an individual skater's style. Furthermore, aerial tricks are further classified as front side tricks where a skater turns into the trick and backside tricks where a skater turns away from the trick. Skaters can grind in regular stance and ride the skateboard with the left foot forward. Skaters can grind in goofy stance and ride the skateboard with the right foot forward. Skaters can switch stance and skate with using the less dominant foot.

Grinding allows a skater abrasive freedom. The addition of sparks to the grind would look really cool. Many spark-generating inventions have addressed the need for such accentuation of the skating experience.

Salvo U.S. Pat. No. 4,832,0407 discloses a pyrotechnic device that amounts to the underside of a skateboard. The device frictionally engages with an abrasive surface travelled by the skateboard. The skateboard shows flint inserts installed in soft plastic fins. Unfortunately, this configuration slows the skateboard and does not allow it to perform grinds or slides.

Kuntz U.S. Pat. No. 4,394,037 discloses a roller skate assembly having a resilient flexible holder biasing flint against an abrasive disk to produce intermittent spark generation. The abrasive disk is mounted on the wheel. This configuration has the advantage of allowing replacement of flint elements, but it would hinder a skateboarder in performing grinds and slides.

Willett U.S. Pat. No. 5,199,726 shows a sparking roller skate having a wheel assembly where flint is engaged with an abrasive drum to produce sparks when slowing the skate.

### OBJECT OF THE INVENTION

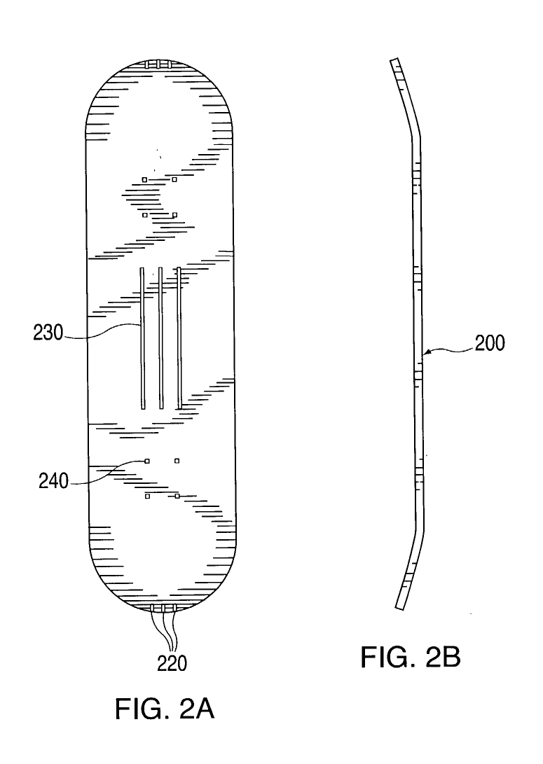

To create a skateboard having sparking inserts (FIG. 2A 220,230, 240) that produce frictional sparking during extreme tricks such as slides and grinds. To position the sparking inserts to be low profile and relatively unobtrusive.

### DESCRIPTION OF THE PREFERRED EMBODIMENT

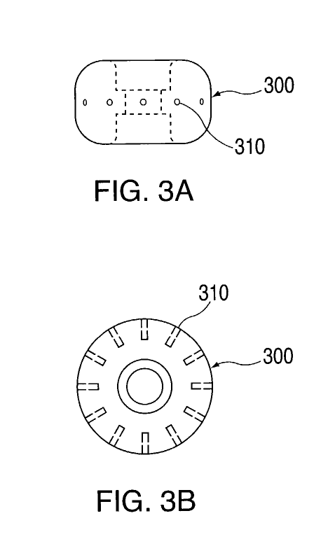

This invention comprises four different embodiments. In the first embodiment, sparking inserts are located on the lower portion of the skate truck, FIG. 1. In the second embodiment, the sparking inserts are located on the skateboard board between the skate trucks as seen in FIG. 2. In the third embodiment, the sparking inserts are located on the nose or tail of the skateboard board as seen in FIG. 2. In the fourth embodiment, the sparking inserts are located on the wheels as seen in FIG. 3.

The sparking inserts 112, 110 may be made of flint or magnesium material. Inserts are uniform and one piece. They do not include internal moving parts. Inserts can be created from larger stock pieces of the same homogenous material. Surface finishing of inserts is optional. A flint insert may be a single solid piece of flint shaped to fit into a particular kind of groove.

In a first embodiment, cylindrical recesses are machined into a lower portion of a skate truck FIG. 1A and receive cylindrical flint inserts 112. Flint inserts can protrude slightly or lie at least substantially flush with the surface of the lower portion of the skate truck. Upon performing a grind maneuver, a skater uses a portion of the flint surface to perform the grind upon a rail.

A lower portion of a skate truck is commonly exposed to a rail during a grind maneuver. The lower portion of a skate truck can be drilled or milled to form recesses capable of receiving flint or magnesium inserts. The recesses in the lower portion of a skate truck receive inserts by interference fit and/or a small amount of adhesive. The flint or magnesium material is integrally formed with the skate truck or skateboard board. Integral formation obscures the sparking insert from view. The sparking insert contributes to structural strength and surface wear resistance of the skate truck lower portion.

Alternatively, FIG. 1B a longitudinal recess holds a bar of flint 110 that protrudes slightly from the lower surface of a skate truck 100. A darker metallic truck can hide the sparking assembly from view. The flint held within the metal skate truck is consumed as the skate truck is worn. The metal to metal connection between sparking insert and metal skate truck retains inserts more tightly than plastic which fails to retain flint inserts tightly during ‘hard’ grinds. Also, due to greater friction and less wear resistance, plastic does not allow a skater to grind with good flow. A variety of sparking inserts can be used. The most common materials that spark upon fictional contact with the ground or a rail are flint and magnesium. The preferred method of installing a flint sparking insert requires milling a long groove 110 in a metal lower portion of a skate truck to allow sparking during a grind. A sparking insert can also be installed in a long groove in a board. Milling a groove into the metal lower portion of a skate truck is preferred.

In a second embodiment, the sparking inserts 230 are located on the board between the skate truck attachment points 240, which are usually a pair of four rectangular oriented holes. The sparking inserts are preferably aligned parallel to the board FIG. 2A. A skater performing a slide exposes the sparking inserts on the underside of the board to the rail. A board, normally made of wood, can receive a milled groove that retains a bar of flint inserted into the groove. The groove is shaped to allow a cylindrical bar of flint to be inserted and glued in place. Flint can protect the board from excessive frictional wear while producing a pyrotechnic effect.

In the third embodiment, the sparking inserts 220 are located on the nose or tail of the skateboard board. A nose or tail of the skateboard is often exposed to the ground during tricks. Sparking inserts integrally formed into the board placed at the terminal ends of the board allow brief pyrotechnic effect during takeoff of an Ollie. Usually, the board has wooden grain parallel to the length of the board. The end of the board is milled to create a groove to accept the sparking insert.

In a fourth embodiment FIGS. 3A-B, wheels can receive cylindrically milled recesses 310 to receive cylindrical sparking inserts 310 mounted perpendicularly to the wheel surface 300. The sparking insert on a wheel creates sound and sparks when the wheel is fictionally engaged with a road surface. At higher speed, wheels begin to spark from rolling engagement with the road.

Call Out List

100 Skateboard Truck

110 Sparking Insert Bar

112 Cylindrical Sparking Insert

200 Skateboard board

220 Sparking end inserts

230 Sparking bar inserts

240 Truck Mounting Area

300 Wheel

310 Skateboard Sparking Insert

1. A skateboard truck comprising: a metal main section to hold two wheels, an upper portion attaching to the underside of a skateboard board, a metal lower portion exposed to a rail during a grind, and a sparking insert integrally formed with the metal lower portion and held in a recess milled in the underside of the metal lower portion of the skateboard truck, whereby the flint inserts create a sparking effect when the underside of the skateboard truck is frictionally worn in a grind upon a rail.

2. The skateboard truck of claim 1, wherein a sparking insert is retained in the recess by glue.

3. The skateboard truck of claim 1, wherein a sparking insert is retained in the recess by interference fit.

4. The skateboard truck of claim 1, wherein the skateboard truck is made of a darker metal color more closely matching a flint sparking insert, whereby making the flint sparking insert more difficult to see.

5. The skateboard truck of claim 1, wherein the sparking insert is retained by interference fit in the recess, which is a tapered slot, said tapered slot retaining a flint bar insert shaped to fit into tapered slot.

6. A skateboard board comprising: a nose at a front end, a tail at a rear end, and a sparking insert integrally formed to the board on the underside portion of the skateboard board, whereby the flint insert creates a sparking effect when the underside of the skateboard board is frictionally worn in a grind.

7. The skateboard board of claim 6 further comprising: a wooden board member having a milled groove in a middle underside portion between two skate trucks, sparking insert bars retained in said milled groove between the two skate trucks, said sparking inserts aligned parallel to the board, said sparking inserts when made of flint protect the underside of the board from excessive frictional wear while producing pyrotechnic effect, whereby a skater can perform a slide exposing the sparking inserts on the underside of the board to a rail.

8. The skateboard board of claim 6 further comprising: a tapered slot retaining a bar flint sparking insert shaped to fit into said tapered slot.

9. The skateboard board of claim 6 further comprising: a nose at a front end, a tail at a rear end, and a flint insert integrally formed to the board on the underside portion of the skateboard board between the skate trucks, whereby a flint sparking insert creates a sparking effect when the underside of the skateboard board is functionally worn in a slide.

10. The skateboard board of claim 6 further comprising: three parallel bars of flint sparking inserts.

11. A skateboard board comprising: a main board portion having a wooden grain parallel to the length of the board, sparking inserts integrally formed into the board located on the nose or tail of the board exposed to the ground during tricks, whereby said sparking inserts placed at the terminal ends of the board allow brief pyrotechnic effect during takeoff of an Ollie.

12. The skateboard board of claim 11 wherein the end of the board is milled to create a groove to accept a sparking insert.

13. The skateboard board of claim 11 wherein a sparking insert is held in a groove by glue.

14. The skateboard board of claim 11 wherein a sparking insert is held in a groove by interference fit.

15. The skateboard board of claim 11 wherein a sparking insert is cylindrically shaped and held in a cylindrical groove.

16. The skateboard board of claim 11 wherein a sparking insert is positioned to meet the front or rear edge of the board, whereby exposing two surfaces.

17. A skateboard wheel comprising: cylindrically milled recesses to receive cylindrical sparking inserts mounted perpendicularly to the wheel surface, sparking inserts integrally formed in recesses to create sound and sparks when the wheel is fictionally engaged with a road surface.

18. The skateboard wheel of claim 17 wherein the sparking inserts are made of flint.
